(19) United States
(12) Patent Application Publication
(10) Pub. No.: US 2005/0166725 A1
(43) Pub. Date: Aug. 4, 2005

(54) Fastening component assistive positioning device

(76) Inventor: Shiu-E Chen, Kaohsiung Hsien (TW)

Correspondence Address: BACON & THOMAS, PLLC, 625 SLATERS LANE, FOURTH FLOOR, ALEXANDRIA, VA, 22314, US

(21) Appl. No.: 10/768,015

(22) Filed: Feb. 2, 2004

(51) Int. Cl. B25B 23/08

(52) U.S. Cl. 81/451

(57) ABSTRACT

A fastening component assistive positioning device comprised of a coupling rod, the coupling rod having a tool head disposed at one end, and an assistive device that is a tubular member movably sleeved on the coupling rod which has a magnetic element in one extremity. Given the said structure, when the tool head front end is placed against the fastening component, the assistive device slides on the coupling rod to the one extremity having the magnetic element and contacts the fastening component, attracting and thereby positioning the fastening component.

### BACKGROUND OF THE INVENTION

1) Field of the invention

The invention relates to powered and manual driver tool accessories, specifically a fastening component assistive positioning device which is temporarily installed on work tools to turn fastening components attracted to them such that the fastening components on the work tool remain firmly positioned and not easily dislodged or shaken off to facilitate screw turning operation.

2) Description of the related art

A conventional screw-type fastening component such as that shown in FIG. 1 is typically turned by a pneumatic tool 1 equipped with an inserted coupling rod 11, the said coupling rod 11 having a magnetically tipped tool head 12 that attracts a screw 13 (a wood screw is shown as an example in the drawing) to facilitate the performance of the screw turning operation; the coupling rod 11 is often hexagonally faceted at one extremity to provide for the insertion of its driven snug-fit section 111 into the chuck 14 of the pneumatic driver 1 and has a hexagonally faceted socket 112 in the opposite extremity, the socket 112 providing for the insertion of the tool head 12; the said tool head 12 is linearly aligned with the upper extent of the screw, the example depicted herein having an I-shaped front end which can also be a cross, a hex socket, a star, crisscross and other shapes.

Referring to FIG. 2, although the screw 13 against the front end 121 of the said tool head 12 is magnetically attracted and thereby positioned at the said area to provide for the turning of the screw, the surface area of magnetic attraction is very small and the magnetic force is limited because the front end 121 of the tool head 12 gradually narrows; if the screw 13 itself has a small head that further reduces the effect, as indicated in FIG. 2, the weight and wobbling propensity of the screw 13 causes the screw 13 to fall off before contact or during the turning operation at the screw fastened object 15 and, furthermore, wobbling makes aiming and positioning difficult, which is why the front end 121 of the tool head 12 utilized is I-shaped, as shown in the drawing.

### SUMMARY OF THE INVENTION

The objective of the invention herein is to provide a fastening component assistive positioning device comprised of a coupling rod, the coupling rod having a tool head disposed at one end, and an assistive device that is a tubular member movably sleeved on the coupling rod which has a magnetic element in one extremity; given the said structure, when the front end of the tool head is placed against the fastening component, the assistive device slides on the coupling rod to the one extremity having the magnetic element and contacts the fastening component, attracting and thereby positioning the fastening component.

### BRIEF DESCRIPTION OF THE DRAWINGS

FIG. 1 is a cross-sectional drawing of a conventional pneumatic driver coupling rod.

FIG. 2 is a cross-sectional drawing of a conventional coupling rod with the inserted tool head attracting a screw.

FIG. 3 is a cross-sectional drawing of the first preferred embodiment coupling rod structure of the invention herein installed on an electric driver.

FIG. 4 is a cross-sectional drawing of the first preferred embodiment coupling rod of the invention herein, with the inserted tool head attracting a screw.

FIG. 5 is a cross-sectional drawing of the second preferred embodiment coupling rod of the invention herein, including the third stop section.

FIG. 6 is a cross-sectional drawing of the second preferred embodiment stop section of the invention herein.

FIG. 7 is a cross-sectional drawing of the third preferred embodiment of the invention herein.

### DETAILED DESCRIPTION OF THE PREFERRED EMBODIMENTS

In the detailed description of the preferred embodiments, it should be noted that identical elements are indicated by the same reference numerals throughout the disclosure.

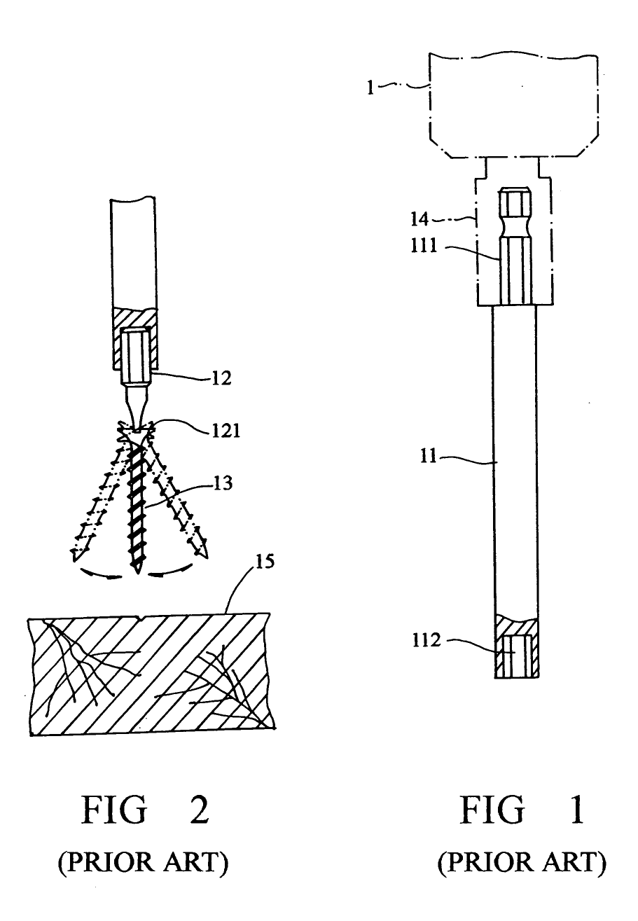

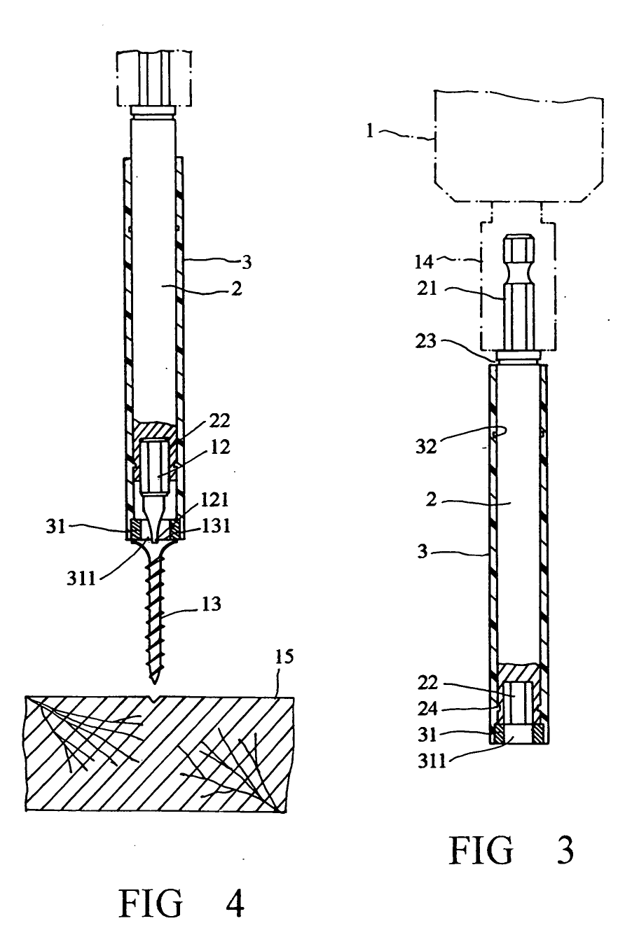

Referring to FIG. 3, the first preferred embodiment of the invention herein is comprised of a pneumatic driver 1 equipped with an insertional coupling rod 2, the coupling rod 2 has a driven snug-fit section 21 at one extremity that provides for the insertion of a hexagonally faceted tip 14, and a hexagonally faceted socket 22 in the opposite extremity; an assistive device 3 that is a tubular member movably sleeved on the coupling rod 2 having a generally annular magnetic element 31 within the inner diameter of one extremity which features an internal hole 311 that is larger than the outer diameters of the socket and the tool head 12 (shown in FIG. 2), but smaller than the outer diameter of the coupling rod 2; a first stop section 23 and a second stop section 24 disposed near the upper and lower extremities of the coupling rod 2 to provide for halting movement, with each consisting of a circular groove around the coupling rod 2 circumference in which a C-shaped ring is seated; and a circular groove 32 formed at an appropriate position within the tubular inner diameter of the assistive device 3.

Referring to FIG. 4, the tool head 12 is inserted into the coupling rod 2 socket 22 through the internal hole 311 of the magnetic element 31 in the assistive device 3, following which the screw 13 is brought against front end of the tool head 12 and subjected to its attraction; the assistive device 3 is then moved forward such that the magnetic element 31 at its front end magnetically positions the said head portion 131 to the extent that dislodging is difficult even if forcefully shaken, enabling easy alignment with the preset mark on the screw fastened object 15 and the turning in of the screw 13.

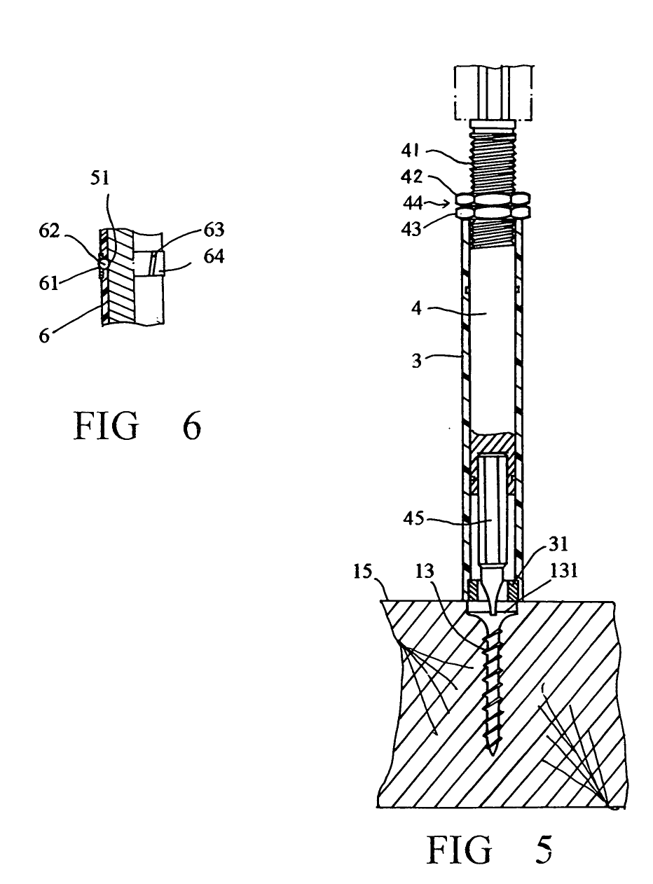

Referring to FIG. 5, the second preferred embodiment of the invention herein has an adjustable position, movable locating third stop section 44 consisting of external threads 41 died around the circumference along the upper extremity of the coupling rod 4 and two nuts 42 and 43 installed on the said external threads 41, enabling the threaded placement of the two nuts 42 and 43 at predetermined positions, the range of the said positioning defining the depth the screw 13 is turned into the screw fastened object 15.

When the screw 13 is attracted onto the front end of the tool head 45 and the coupling rod 4 is against the screw fastened object 15, and the top surface of the head portion 131 at the upper extent of the driven screw 13 becomes level with the surface of the screw fastened object 15, the magnetic element 31 at the front end of the said assistive device 3 is checked against the surface of the fastened object 15, at which time the pneumatic driver 1 tip 14 inserted in the coupling rod 4 snug-fit section 41 continues to shift downward, such that the tool head 45 at the front end of the coupling rod 4 continues turning the screw 13 into the screw fastened object 15 until the third stop section 44 nuts 42 and 43 press against the edge at the upper extremity of the assistive device 3, no longer allowing the continued forward movement of the tool head 4 driven by the coupling rod 4; as such, after removal from the entire attached assistive device 3 of the coupling rod 4, the screw turning task is continued and each screw is driven an equal depth.

Referring to FIG. 6, a circular groove 51 at a predetermined position around the circumference of the coupling rod 5 is utilized; additionally, a hole 61 is formed in the circumference of the assistive device 6 tubular member and a spherical body 62 is disposed in the hole 61, enabling the sleeving on of an elastic C-shaped annular element 64 having a gap 63 over the spherical body 62 outside the circumference of the assistive device 6 tubular member; when the coupling rod 5 moves downward to the circular groove 51 and is subjected to the insertion of the spherical body 62 on the assistive device 6, the coupling rod 5 relatively at the assistive device 6 no longer moves, which in terms of effective checking capability is equivalent to the third stop section 44 in the second preferred embodiment.

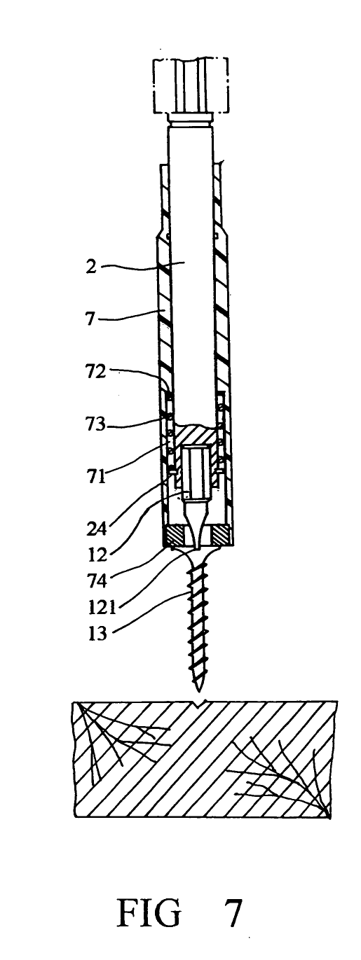

Referring to FIG. 7, in the third preferred embodiment of the invention herein, an extra space 71 is formed at the lower extent and inner diameter of the assistive device 7, a shoulder section 72 is formed along the inner diameter, and an elastic component 73 is disposed between the shoulder section 72 and the coupling rod 2 second stop section 24, with the strength of the said elastic component 73 sufficient to push up the assistive device 7 movably ensleeved on the coupling rod 2, but less than that of the pull on the screw 13 from the magnetic element 74; therefore, when the upper end head portion of the screw 13 moves the assistive device 7 downward due to the magnetic attraction at the front end of the tool head 12 and the circumference of the screw 13 is subjected to the magnetic attraction of the annular magnetic element 74, the elastic component 73 between the shoulder section 72 and the second stop section 72 is compressed and stores a rebound force, but the rebound force is smaller than that of the pull on the screw 13 from the magnetic element 74; after completion of the screw 13 turning task, the coupling rod 2 as well as the assistive device 7 moves away from the screw 13, and the rebound force of the elastic component 73 moves the assistive device 7 back towards the upper extremity of the coupling rod 2.

In summation of the foregoing section, the preferred embodiments of the invention herein can be temporarily placed in work tools to turn fastening components that are attracted to them such that the fastening component on the work tools remain firmly positioned and not easily dislodged or shaken off to facilitate screw turning operation; they are not limited only to screws and, furthermore, not limited only to usage with the short, small tool heads, such as that shown in FIG. 4, but can also be utilized with tool heads of greater length, as also indicated in FIG. 4; additionally, since the assistive device can be brought upward from the coupling rod to axially extend its length, it can be lowered into deep holes or recesses during operation with other applicable metal components magnetically attracted to the magnetic element at the front end of the assistive device; and the design of the assistive device is such that it is not only usable with the electric tools or the coupling rod embodiments elaborated in the detailed description herein, but by the same reasoning capable of being separately utilized on conventional screwdrivers.

While the present invention has been described in connection with what is considered the most practical and preferred embodiments, it is understood that the invention herein is not limited to the disclosed embodiments but is intended to cover various arrangements included within the spirit and scope of the broadest interpretations and equivalent arrangements.

1. A fastening component assistive positioning device comprised of:
A coupling rod, the said coupling rod having a tool head disposed at one end, and an assistive device that is a tubular member movably sleeved on the said coupling rod which has a magnetic element in one extremity.
Given the said structure, when the front end of the tool head is placed against the fastening component, the said assistive device slides on the said coupling rod to the one extremity having the said magnetic element and contacts the fastening component, attracting and thereby positioning the fastening component.

2. As mentioned in claim 1 of the fastening component assistive positioning device of the invention herein, the said coupling rod has a driven snug-fit section that is hexagonally faceted at one extremity that provides for pneumatic driver tool chuck insertion.

3. As mentioned in claim 1 of the fastening component assistive positioning device of the invention herein, the said coupling rod has a hexagonally faceted socket that provides for tool head insertion.

4. As mentioned in claim 1 of the fastening component assistive positioning device of the invention herein, the said magnetic element is generally annular in shape and has an outer diameter that is larger than that of the said tool head, but smaller than the outer diameter of the said coupling rod at its internal hole.

5. As mentioned in claim 1 of the fastening component assistive positioning device of the invention herein, the said coupling rod has a first stop section and a second stop section disposed near its upper and lower extremities; the said assistive device moves rearward to the said first stop section, following which it is immobilized to prevent further movement and the said assistive device moves forward but is halted by the said second stop section to prevent further forward movement that results in the dislodging of the fastening component.

6. As mentioned in claim 5 of the fastening component assistive positioning device of the invention herein, the said first stop section and the said second stop section each consist of a circular groove around the said coupling rod circumference in which a C-shaped snap ring is seated and, furthermore, a circular groove formed at an appropriate position within the tubular inner diameter of the said assistive device.

7. As mentioned in claim 1 of the fastening component assistive positioning device of the invention herein, the said coupling rod has an adjustable position, movable third stop section, the range of which defines the depth the fastening component is turned into a screw fastened object.

8. As mentioned in claim 7 of the fastening component assistive positioning device of the invention herein, the said third stop section consists of external threads died around circumference along the upper extremity of the said coupling rod and two nuts installed on the said external threads.

9. As mentioned in claim 1 of the fastening component assistive positioning device of the invention herein, the said coupling rod has a circular groove at a predetermined position around its circumference; additionally, a hole is formed in the circumference of the said assistive device tubular member and a spherical body is disposed in the said hole, enabling the sleeving on of an elastic annular element outside the circumference of the said assistive device tubular member.

10. As mentioned in claim 1 of the fastening component assistive positioning device of the invention herein, the said assistive device and the said coupling rod have an elastic component disposed between them; after completion of the turning task, the rebound force of the elastic component moves the said assistive device back towards the upper extremity of the said coupling rod.
